(19) United States
(12) Patent Application Publication
(10) Pub. No.: US 2022/0065413 A1
(43) Pub. Date: Mar. 3, 2022

(54) LIGHT EFFECT PROJECTION DEVICE

(71) Applicants: Zhenghai Wang, Zhuhai City (CN); Shenzhen Haoguangcai Technology Co., Ltd, Shenzhen (CN)

(72) Inventor: Zhenghai Wang, Zhuhai City (CN)

(21) Appl. No.: 17/460,289

(22) Filed: Aug. 29, 2021

(30) Foreign Application Priority Data
Sep. 1, 2020 (CN) 202021883663.X
Aug. 2, 2021 (CN) 202121786678.9

(51) Int. Cl. F21S 8/00; F21V 14/00; F21V 14/08; F21V 5/04

(52) U.S. Cl. CPC F21S 8/035; F21V 5/04; F21V 14/08; F21V 14/006

(57) ABSTRACT

Disclosed is a light effect projection device, including a control unit, a condensing diffraction assembly and a first lamp source, wherein the first lamp source and the control unit are both fixed in a housing, the first lamp source is electrically connected to the control unit, the condensing diffraction assembly is located above the first lamp source, the condensing diffraction assembly at least includes a plastic condensing lens, the condensing lens is shaped like a spherical crown or a semi-sphere, an incident plane of the condensing lens is concave, and the incident plane or an emergent plane of the condensing lens is of a polyhedral structure; further including a driving unit which is fixedly arranged in the housing and electrically connected to the control unit, wherein one part of the condensing diffraction assembly is fixed at a power output end of the driving unit for driving connection.

### TECHNICAL FIELD

The present invention relates to the technical field of projection equipment, and in particular, to a light effect projection device.

### BACKGROUND

At present, the starry sky projection lamp in the market generally adopts direct light source to realize light effect projection. However, this technology requires a large-size glass lens, and the lens itself has high manufacturing requirement and is heavier, thereby easily affecting the appearance and structural design of products. In addition, the glass lens is thick and heavy, so when falling, the product is liable to damage and the service life of the product is affected.

Therefore, people want to set a light effect projection device for simulating the starry sky.

### SUMMARY

An objective of the present invention is to provide a light effect projection device for the defects and shortcomings in the prior art. The light effect projection device has the advantages of high expansion capability, high pattern brightness, large pattern projection range, high definition and capabilities of effectively reducing cost and maintaining the volume of a project.

In order to achieve the above objective, the present invention adopts the following technical solution, a light effect projection device includes: a control unit, a condensing diffraction assembly and a first lamp source, wherein the first lamp source and the control unit are both fixed in the housing, the first lamp source is electrically connected to the control unit, the condensing diffraction assembly is located above the first lamp source, the condensing diffraction assembly at least comprises a plastic condensing lens, the condensing lens is shaped like a spherical crown or a semi-sphere, an incident plane of the condensing lens is concave, and the incident plane or an emergent plane of the condensing lens is of a polyhedral structure.

The light effect projection device further includes: a driving unit which is fixedly arranged in the housing and electrically connected to the control unit, wherein one part of the condensing diffraction assembly is fixed at a power output end of the driving unit for driving connection. The condensing diffraction assembly includes: the condensing lens, a first condensing lens and a first imaging lens; the first plastic imaging lens, the first condensing lens and the condensing lens are arranged sequentially along a light path of a first light source; the first imaging lens and the first condensing lens are both fixedly arranged in the housing; the power output end of the driving unit is connected to an axis of the condensing lens; and the driving unit is configured to drive the condensing lens to rotate relative to the first condensing lens.

A plurality of protruded portions are distributed on an emergent plane of the first imaging lens, and trenches are formed among the plurality of protruded portions.

The condensing diffraction assembly includes: two condensing lenses which are arranged sequentially along a light path of a first light source; one of the condensing lenses is fixedly arranged on the housing, and an axis of the other one of the condensing lenses is connected to the power output end of the driving unit; and the driving unit is capable of driving one of the condensing lenses to rotate relative to the other one of the condensing lenses.

The two condensing lenses are respectively a first condensing lens and a second condensing lens; the second condensing lens is located between the first condensing lens and the first lamp source; and the power output end of the driving unit is connected to an axis of the first condensing lens.

The first condensing lens covers the second condensing lens.

The driving unit is a motor.

The condensing diffraction assembly includes: the condensing lens and a second imaging lens, wherein the condensing lens is fixedly mounted on the housing; the second imaging lens is fixedly mounted in the housing; the second imaging lens is located between a first light source and the incident plane of the condensing lens; and a plurality of protruded portions are arranged on the second imaging lens, and trenches are formed among the plurality of protruded portions.

The light effect projection device further includes a second light source, a second condensing lens, a film and a focusing lens, wherein the second light source is electrically connected to the control unit; the film is provided with a light-transmitting area; the second light source, the second condensing lens, the film and the focusing lens are arranged sequentially along a second light path; and the second light source, the second condensing lens, the film and the focusing lens are all fixedly arranged on the housing.

The second light source is a second light-emitting diode.

After the above technical solution is adopted, the present invention has the following beneficial effects:

1. the light effect projection device includes: a control unit, a condensing diffraction assembly and a first lamp source, wherein the first lamp source and the control unit are both fixed in the housing, the first lamp source is electrically connected to the control unit, the condensing diffraction assembly is located above the first lamp source, the condensing diffraction assembly at least includes a plastic condensing lens, the condensing lens is shaped like a spherical crown or a semi-sphere, an incident plane of the condensing lens is concave, and the incident plane or an emergent plane of the condensing lens is of a polyhedral structure. Light beams with different colors are emitted by the first lamp source, and then are condensed and dispersed through the condensing diffraction assembly, so that the light effect projection device projects the pattern of starry sky. The pattern projected by the polyhedral structure of the incident plane or the emergent plane of the condensing lens has the effects of high brightness and definition, and the manufacturing cost of the condensing lens is less than that of an interference wheel in the prior art, so the manufacturing cost of the light effect projection device can be reduced by replacing the interference wheel with the condensing lens.

2. The light effect projection device further includes a driving unit; the condensing diffraction assembly includes: a condensing lens, a first condensing lens and a first plastic imaging lens; and the driving unit is used to drive the condensing lens to rotate relative to the first condensing lens. If it is necessary to change the effect of the dynamic light effect and expand the structure, the imaging lens is fixedly arranged, only the light source, the condensing lens and the imaging lens are required, the motor is not required, and a plurality of light sources can enter the rotating condensing lens after passing through the imaging lens to generate a dynamic effect, so that the cost is effectively reduced. Since the plurality of light sources and the imaging lens are arranged in a coverage range of the condensing lens, the volume change of the projection device is small and the appearance of the projection device is not affected.

3. The light effect projection device further includes a driving unit; the condensing diffraction assembly includes: two condensing lenses; the driving unit is in driving connection with one of the condensing lenses; and the first condensing lens and the second condensing lens condense light beams emitted by the LED lamp for twice, so that the pattern projected by the light effect projection device has high brightness, large range and high definition.

### DESCRIPTION OF THE DRAWINGS

To describe the technical solutions in the embodiments of the present invention or in the prior art more clearly, the accompanying drawings required to describe the embodiments or the prior art are briefly described below. It is obvious that the accompanying drawings described below are only some embodiments of the present invention. It is apparent to those of ordinary skill in the art that other drawings may be further obtained based on the accompanying drawings without creative effort.

FIG. 1 is a structural schematic diagram of an embodiment 1 of a light effect projection device according to the present invention;

FIG. 2 is a structural schematic diagram of a condensing lens of a light effect projection device according to the present invention;

FIG. 3 is a structural schematic diagram of a first imaging lens of a light effect projection device according to the present invention;

FIG. 4 is an extended structural schematic diagram of an embodiment 1 of a light effect projection device according to the present invention;

FIG. 5 is a structural schematic diagram of an embodiment 2 of a light effect projection device according to the present invention; and

FIG. 6 is a structural schematic diagram of an embodiment 3 of a light effect projection device according to the present invention.

Reference numerals: 1. Battery unit; 2. Control unit; 3. Condensing diffraction assembly; 4. First lamp source; 5. Driving unit; 31. First imaging lens; 32. First condensing lens; 33. Condensing lens; 331. First condensing lens; 332. Second condensing lens; 34. Second imaging lens; 6. Second light source; 7. Second condensing lens; 8. Film; 9. Focusing lens; 12. Connecting portion.

### DETAILED DESCRIPTION OF EMBODIMENTS

The present invention is further described below in detail with reference to the accompanying drawings.

The specific embodiment is only intended to explain the present invention, but not to limit the present invention. Those skilled in the art may make modification without creative contribution on this embodiment as required after reading the specification, but this embodiment should be protected by the Patent law as long as it is within the scope of the claims of the present invention.

### Embodiment 1

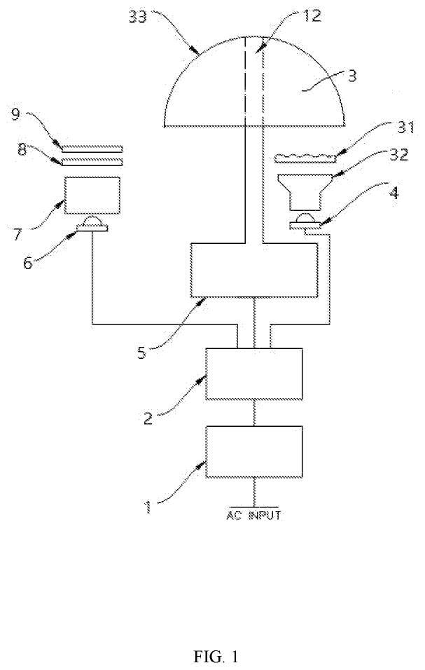

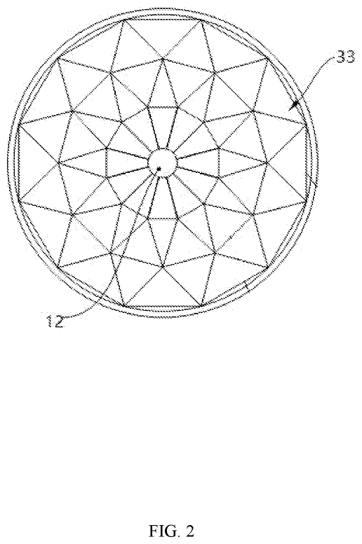

This embodiment relates to a light effect projection device. As shown in FIG. 1, the light effect projection device includes: a control unit 2, a condensing diffraction assembly 3 and a first lamp source 4, wherein the first lamp source 4 is electrically connected to the control unit 2, the condensing diffraction assembly 3 is located above the first lamp source 4, as shown in FIG. 2, the condensing diffraction assembly 3 at least includes a plastic condensing lens 33, the condensing lens 33 is shaped like a spherical crown or a semi-sphere, an incident plane of the condensing lens 33 is concave, and the incident plane o an emergent plane of the condensing lens 33 is of a polyhedral structure. In this embodiment, the light effect projection device further includes a battery unit 1 which is electrically connected to the control unit 2. Due to the battery unit 1, the light effect projection device is more convenient and free to use, and may be used without being affected by site factors. The first lamp source 4 is an LED lamp, and the LED lamp has more than two light-emitting colors. The condensing lens 33 is made of transparent plastic, the first imaging lens 31 is a transparent plastic sheet, and the first imaging lens 31 is provided with a flat incident plane and an uneven emergent plane.

It should be noted that light beams with different colors are emitted by the first lamp source 4, and then are condensed and dispersed through the condensing diffraction assembly 3, so that the light effect projection device projects the pattern of starry sky. The pattern projected by the polyhedral structure of the incident plane or the emergent plane of the condensing lens 33 has the effects of high brightness, high definition and large projection range, and the manufacturing cost of the condensing lens 33 is less than that of an interference wheel in the prior art, so the manufacturing cost of the light effect projection device can be reduced by replacing the interference wheel with the condensing lens 33.

Preferably, as shown in FIG. 1, the light effect projection device further includes: a driving unit 5 which is fixedly arranged in the housing and is electrically connected to the control unit 2; and one part of the condensing diffraction assembly 3 is fixed at a power output end of the driving unit 5 for driving connection. The driving unit 5 is a motor. The driving unit 5 drives part of the condensing diffraction assembly 3, so that the pattern projected by the light effect projection device generates dynamic change, thereby enhancing the visual effect of the nebulous pattern.

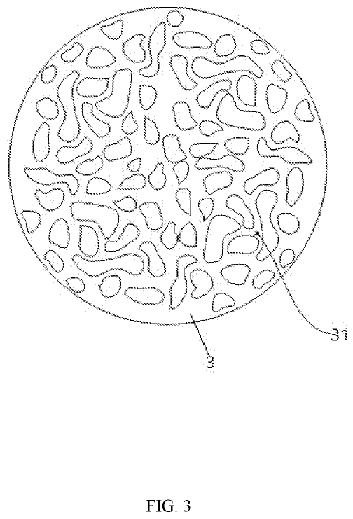

Preferably, as shown in FIG. 1, FIG. 2 and FIG. 3, the condensing diffraction assembly 3 includes: a condensing lens 33, a first condensing lens 32 and a first plastic imaging lens 31.

The first imaging lens 31, the first condensing lens 32 and the condensing lens 33 are arranged sequentially along a light path of a first light source, the first imaging lens 31 and the first condensing lens 32 are both fixedly arranged in the housing, the power output end of the driving unit 5 is connected to an axis of the condensing lens 33, and the driving unit 5 is used to drive the condensing lens 33 to rotate relative to the first condensing lens 32. In this embodiment, a plurality of protruded portions are distributed on an emergent plane of the first imaging lens 31, and trenches are formed among the plurality of protruded portions.

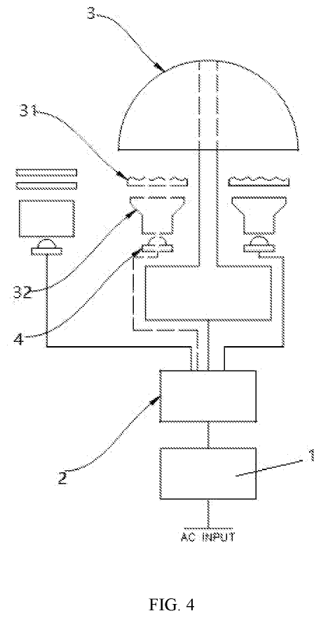

It may be seen from the above solution that as shown in FIG. 4, in the light effect projection device, the first imaging lens 31 is fixedly arranged, the condensing lens 33 is driven by the motor to rotate, the incident plane of the condensing lens 33 is of a polyhedral structure, and a plurality of prismatic, concave or convex refraction plane units are actually formed. After the condensing lens 33 rotates, light of the first light source passes through the first imaging lens 31 and then enters the plurality of moving refraction plane units of the condensing lens 33, and finally, the light emitted from the condensing lens 33 can present a corresponding dynamic light effect. At this time, if it is necessary to change the effect of the dynamic light effect and expand the structure, the imaging lens is fixedly arranged, only the light source, the condensing lens and the imaging lens are required, the motor is not required, and a plurality of light sources can enter the rotating condensing lens after passing through the imaging lens 33 to generate a dynamic effect, so that the cost is effectively reduced. Since the plurality of light sources and the imaging lens are arranged in a coverage range of the condensing lens 33, the volume change of the projection device is small and the appearance of the projection device is not affected.

### Embodiment 2

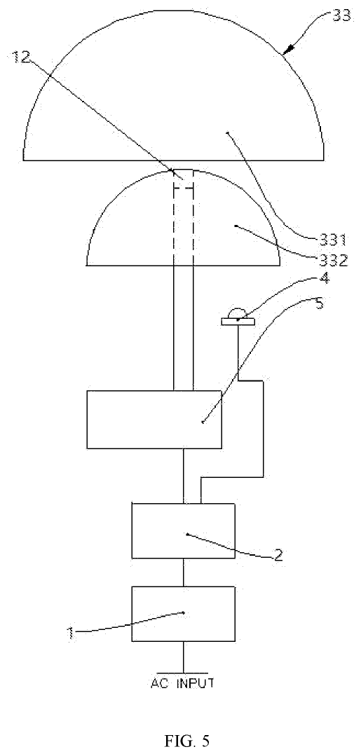

The main difference between this embodiment and the embodiment 1 is as follows: as shown in FIG. 5, the condensing diffraction assembly 3 includes: two condensing lenses 33 which are arranged sequentially along a light path of a first light source; one of the condensing lenses 33 is fixedly arranged on the housing, and an axis of the other one of the condensing lenses 33 is connected to the power output end of the driving unit 5; and the driving unit 5 may drive one of the condensing lenses 33 to rotate relative to the other one of the condensing lenses 33.

Preferably, the two condensing lenses 33 are respectively a first condensing lens 331 and a second condensing lens 332; the second condensing lens 332 is located between the first condensing lens 331 and the first lamp source 4; and the power output end of the driving unit 5 is connected to the axis of the first condensing lens 331. In this embodiment, the first condensing lens 331 covers the second condensing lens 332. It should be noted that at least one part of the second condensing lens 332 may be located in the first condensing lens 331. Or at least one part of the second condensing lens 332 may be located in the first condensing lens 331, so that the visual effect of the nebulous pattern projected by the light effect projection device is improved.

Preferably, the second condensing lens 332 is extensibly provided with a connecting portion 12 along the axis of the second condensing lens 332 from the incident plane of the second condensing lens 332. The driving unit 5 includes a motor and a speed-reducing wheel set, wherein the motor is electrically connected to the control unit 2; an input wheel of the speed-reducing wheel set fixedly sleeves a motor shaft of the motor; and an output wheel of the speed-reducing wheel set fixedly sleeves the connecting portion 12. Through the structural design of the driving unit 5, the second condensing lens 332 can rotate at a proper speed, thereby ensuring the dynamic visual effect of the nebulous pattern projected by the light effect projection device.

It can be seen from the above that when the light effect projection device works, the LED lamp emits a light beam, and the light beam sequentially passes through the second condensing lens 332 and the first condensing lens 331 and then is emitted out of the housing from the first condensing lens 331. When the light beam emitted by the LED lamp passes through the second condensing lens 332, the second condensing lens 332 condenses and disperses the light beam for the first time. When the light beam passes through the first condensing lens 331, the second condensing lens 332 condenses and disperses the light beam for the second time, thereby enabling the light effect projection device to project the nebulous pattern. The driving unit 5 may drive the second condensing lens 332 to rotate, so that the nebulous pattern projected by the light effect projection device dynamically changes, thereby enhancing the visual effect of the nebulous pattern. Since the first condensing lens 331 and the second condensing lens 332 condense the light beam emitted by the LED lamp for twice, so that the pattern projected by the light effect projection device has high brightness, large range and high definition. The projection range of this embodiment is more than one time larger than the projection range of the embodiment 1. In addition, since the manufacturing cost of the condensing lens 33 is less than that of the interference wheel in the prior art, the manufacturing cost of the light effect projection device can be reduced by replacing the interference wheel with the condensing lens 33.

### Embodiment 3

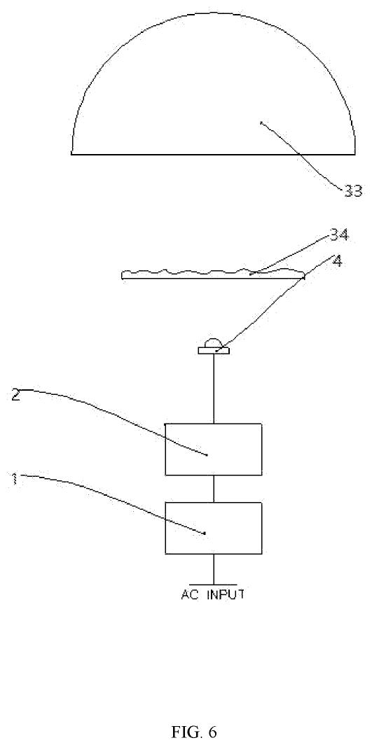

As shown in FIG. 6, the main difference between this embodiment and the embodiment 1 or 2 is as follows: the condensing diffraction assembly 3 includes: a condensing lens 33 and a second imaging lens 34, wherein the condensing lens 33 is fixedly mounted on the housing, the second imaging lens 34 is fixedly mounted in the housing, the second imaging lens 34 is located between the first light source and the incident plane of the condensing lens 33, a plurality of protruded portions are arranged on the second imaging lens 34, and trenches are formed among the plurality of protruded portions.

It should be noted that when the light effect projection device works, the LED lamp emits a light beam, and the light beam sequentially passes through the second imaging lens 34 and the condensing lens 33 and then is emitted out of the housing from the condensing lens 33. When the light beam emitted by the LED lamp passes through the second imaging lens 34, the second imaging lens 34 performs diffused transmission on the light beam. When the light beam passes through the condensing lens 33, the second condensing lens 332 condenses and disperses the light beam for twice, thereby enabling the light effect projection device to project the nebulous pattern.

### Embodiment 4

Based on the above embodiment 1 or 2 or 3, in this embodiment, the light effect projection device further includes a second light source 6, a second condensing lens 7, a film 8 and a focusing lens 9. The second light source 6 is electrically connected to the control unit 2. The film 8 is provided with a light-transmitting area. The second light source 6, the second condensing lens 7, the film 8 and the focusing lens 9 are arranged sequentially along a second light path, and are all fixedly arranged on the housing. In this embodiment, the second light source 6 is a second light-emitting diode. The light-transmitting area is a projection pattern.

The above is only used to describe the technical solution of the present invention, but not to limit it. Other modifications or equivalent substitutions on the technical solution of the present invention made by a person of ordinary skill in the art should be included in the scope of the claims of the present invention as long as they do not depart from the spirit and scope of the technical solution of the present invention.

1. A light effect projection device, comprising: a control unit (2), a condensing diffraction assembly (3) and a first lamp source (4), wherein the first lamp source (4) and the control unit (2) are both fixed in a housing, the first lamp source (4) is electrically connected to the control unit (2), the condensing diffraction assembly (3) is located above the first lamp source (4), the condensing diffraction assembly (3) at least comprises a plastic condensing lens (33), the condensing lens (33) is shaped like a spherical crown or a semi-sphere, an incident plane of the condensing lens (33) is concave, and the incident plane or an emergent plane of the condensing lens (33) is of a polyhedral structure.

2. The light effect projection device according to claim 1, further comprising: a driving unit (5) fixedly arranged in the housing and electrically connected to the control unit (2), wherein one part of the condensing diffraction assembly (3) is fixed at a power output end of the driving unit (5) for driving connection.

3. The light effect projection device according to claim 2, wherein the condensing diffraction assembly (3) comprises: the condensing lens (33), a first condensing lens (32) and a first plastic imaging lens (31); the first imaging lens (31), the first condensing lens (32) and the condensing lens (33) are arranged sequentially along a light path of a first light source; the first imaging lens (31) and the first condensing lens (32) are both fixedly arranged in the housing; the power output end of the driving unit (5) is connected to an axis of the condensing lens (33); and the driving unit (5) is configured to drive the condensing lens (33) to rotate relative to the first condensing lens (32).

4. The light effect projection device according to claim 3, wherein a plurality of protruded portions are distributed on an emergent plane of the first imaging lens (31), and trenches are formed among the plurality of protruded portions.

5. The light effect projection device according to claim 2, wherein the condensing diffraction assembly (3) comprises: two condensing lenses (33) which are arranged sequentially along a light path of a first light source; one of the condensing lenses (33) is fixedly arranged on the housing, and an axis of the other one of the condensing lenses (33) is connected to the power output end of the driving unit (5); and the driving unit (5) is capable of driving one of the condensing lenses (33) to rotate relative to the other one of the condensing lenses (33).

6. The light effect projection device according to claim 5, wherein the two condensing lenses (33) are respectively a first condensing lens (331) and a second condensing lens (332); the second condensing lens (332) is located between the first condensing lens (331) and the first lamp source (4); and the power output end of the driving unit (5) is connected to an axis of the first condensing lens (331).

7. The light effect projection device according to claim 6, wherein the first condensing lens (331) covers the second condensing lens (332).

8. The light effect projection device according to claim 2, wherein the driving unit (5) is a motor.

9. The light effect projection device according to claim 1, wherein the condensing diffraction assembly (3) comprises: the condensing lens (33) and a second imaging lens (34); the condensing lens (33) is fixedly mounted on the housing; the second imaging lens (34) is fixedly mounted in the housing; the second imaging lens (34) is located between a first light source and the incident plane of the condensing lens (33); and a plurality of protruded portions are arranged on the second imaging lens (34), and trenches are formed among the plurality of protruded portions.

10. The light effect projection device according to claim 1, wherein the first lamp source (4) is an LED lamp, and the LED lamp has more than two light-emitting colors.

11. The light effect projection device according to claim 1, further comprising a second light source (6), a second condensing lens (7), a film (8) and a focusing lens (9), wherein
the second light source (6) is electrically connected to the control unit (2);
the film (8) is provided with a light-transmitting area; and
the second light source (6), the second condensing lens (7), the film (8) and the focusing lens (9) are arranged sequentially along a second light path, and are all fixedly arranged on the housing.

12. The light effect projection device according to claim 11, wherein the second light source (6) is a second light-emitting diode.

13. The light effect projection device according to claim 1, further comprising a battery unit (1) electrically connected to the control unit (2).
